(19) United States
(12) Patent Application Publication
(10) Pub. No.: US 2023/0074853 A1
(43) Pub. Date: Mar. 9, 2023

(54) SPRAY HEAD CONFIGURED TO CLEAN TEAT OF DAIRY ANIMAL

(71) Applicant: D.F. van Staveren Holding B.V., Capelle aan den IJssel (NL)

(72) Inventor: Arie VAN STAVEREN, Capelle aan den IJssel (NL)

(21) Appl. No.: 17/793,794

(22) PCT Filed: Jan. 21, 2021
(86) PCT No.: PCT/NL2021/050037

§ 371 Date: Jul. 19, 2022

(30) Foreign Application Priority Data
Jan. 21, 2020 (NL) 2024718
May 22, 2020 (NL) 2025652

(51) Int. Cl. A01J 7/04; A01J 5/08

(52) U.S. Cl. CPC A01J 7/04; A01J 5/08

(57) ABSTRACT

The present disclosure relates to a spray head configured to clean a teat of a dairy animal, comprising a body comprising an inner contour at least partly enclosing a cleaning zone that is configured to receive the teat of the dairy animal; a fluid inlet; and at least one nozzle that is in fluid connection with the fluid inlet and is arranged along at least part of the inner contour of the body.

The present disclosure relates to a spray head to clean a teat of a dairy animal.

In dairy farming, milk is typically extracted from dairy animals by means of a milking apparatus comprising one or more teat cups. Each of the teat cups may be placed on a respective one of the dairy animal's teats either by hand or in an automated manner, as is the case in automated milking robots.

During a process of extracting milk from a dairy animal an adequate level of hygiene is of paramount importance. The reason for this is twofold. Firstly, when a dairy animal excretes milk, the milk ducts within the teats of the dairy animal dilate. This results in an increased likelihood for foreign matter—including bacteria and other potentially harmful microorganisms—to enter said milk duct, which may result in an infection of the mammary gland of the dairy animal. Secondly, extracted milk is typically ultimately intended for human consumption while simultaneously being susceptible to spoilage, in particular when contaminated with potential contaminants that are present in a farm environment.

It is for the above reasons that dairy farmers often take extensive hygiene precautions, one of which being cleaning of the teats of the dairy animal prior to placement of the teat cups and subsequent milk extraction. Cleaning of the teats of a dairy animal may be time-consuming and labour-intensive, as it is not unheard of for the teats of dairy animals to be covered in grime and/or feces.

As such, there exist a number of specialised devices in the art for the purpose of cleaning a dairy animal's teats prior to milk extraction. These devices are known to be relatively large and bulky, making them suitable for only certain dairy farming environments. Moreover, such devices are typically relatively costly and require a substantial financial investment when purchased. Another identified drawback of known teat cleaning devices is the fact that they are often reliant on mechanically driven brushes, which has been observed to induce discomfort and anxiety in some dairy animals when their teats are cleaned using such devices.

An objective of the present disclosure is to provide a teat cleaning device for dairy animals that is improved relative to the prior art and wherein at least one of the above stated problems is obviated or abated. This objective is achieved with a spray head according to the present invention, which is configured to clean a teat of a dairy animal and comprises a body comprising an inner contour at least partly enclosing a cleaning zone that is configured to receive the teat of the dairy animal; a fluid inlet; and at least one nozzle that is in fluid connection with the fluid inlet and is arranged along at least part of the inner contour of the body.

The spray head according to the present invention may be compactly sized on account of the above stated features and easily connected to an available fluid (water) source, thereby abating one of the aforementioned primary drawbacks of known teat cleaning devices. Moreover, the spray head according to the present invention exhibits a design that is simplified relative to known prior art devices and comprises few or none moving parts. Consequently, said spray head can be manufactured relatively cheaply using low-costs manufacturing techniques, such as injection moulding or metal stamping, and exhibits a high degree of reliability during use.

The present disclosure moreover relates to a milking apparatus comprising a spray head according to the present disclosure.

Preferred embodiments of a spray head in accordance with the present invention are subject of the appended dependent claims.

The various aspects and features described and shown in the disclosure can be applied, individually, wherever possible, or can be applied in combination. These individual aspects, and in particular the aspects and features described in the appended dependent claims, may be made subject of further divisional patent applications.

In the following description preferred embodiments of the present invention are further elucidated with reference to the drawing, in which:

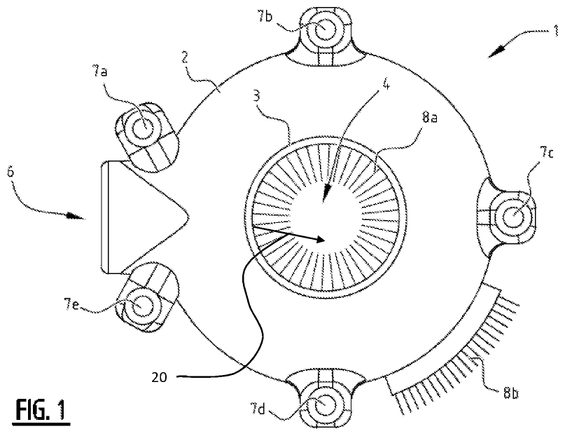

FIG. 1 illustrates a top-down view of an exemplary embodiment of a spray head in accordance with the present invention;

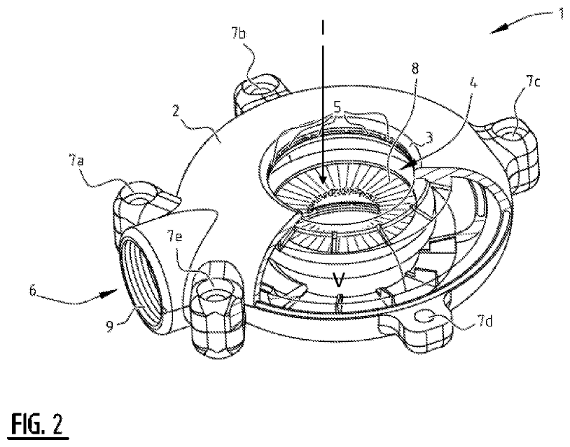

FIG. 2 illustrates a perspective view of another exemplary embodiment of a spray head;

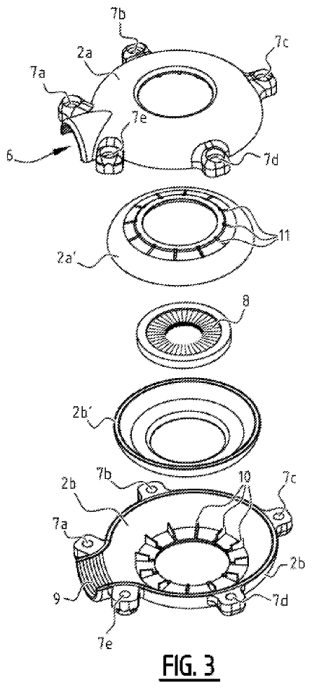

FIG. 3 illustrates exploded view elucidating a structure of the spray head of FIG. 2; and

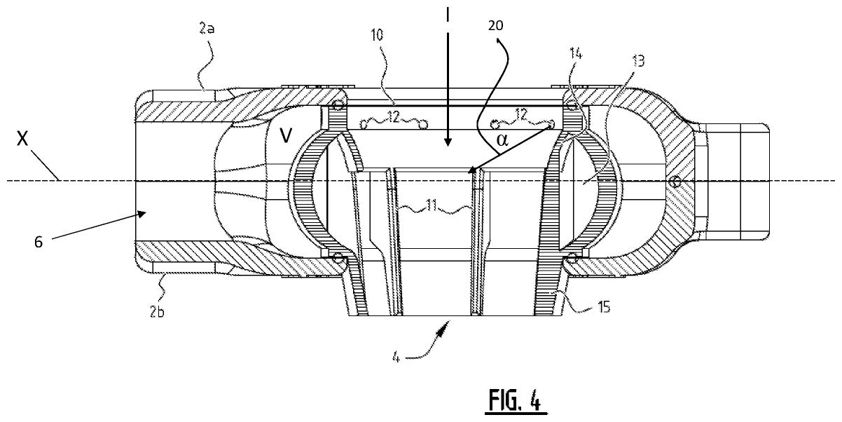

FIG. 4 illustrates a cross-sectional view of further exemplary embodiment of a spray head

FIG. 1 illustrates an exemplary embodiment of a spray head 1. Spray head 1 comprises a ring-shaped or circular body 2 of which an inner contour 3 defines and encloses a cleaning zone 4. Cleaning zone 4 is dimensioned sufficiently large to receive therein a teat of a dairy animal, in a direction parallel to the viewing direction and perpendicular to a plane of the paper when viewing FIG. 1, for the purpose of cleaning said teat.

As is best illustrated in FIG. 2, spray head 1 furthermore comprises one or more nozzles 5 arranged along at least part of inner contour 3 of body 2. Each one of the at least one nozzles 5 is in fluid connection with a fluid inlet 6, so that fluid may be forcefully discharged through at least one of nozzles 5, thereby performing a spray-like cleaning operation on a teat received in cleaning zone 4.

In the depicted embodiments of spray head 1 each one of nozzles 5 comprises or is formed by an aperture in body 2.

Fluid inlet 6 preferably comprises a connector configured to connect spray head 1 to an available fluid or water source, such as a hose connected to a tap of the type that is commonly present on the majority of dairy farms. In the exemplary embodiment of FIG. 2, the connector of fluid inlet 6 comprises a threaded screw.

Because body 2 comprises inner contour 3 at least partly enclosing cleaning zone 4 with at least one nozzle 5 being arranged along inner contour 3, fluid that is forcefully discharged through the at least one nozzle 5 may be discharged in at least two different radial directions of cleaning zone 4, thus impacting and cleaning different faces of the teat received therein simultaneously. As such, said teat is cleaned in a manner that is efficient both in terms of required cleaning time and achieved cleaning result.

In the embodiments depicted in the appended figures, body 2 is embodied by a housing 2 comprising an inner space V. As is best illustrated in FIG. 3, housing 2 may comprise at least two complementary parts, first outer half 2a and second outer half 2b, that are attached to one another. Mutual attachment of first outer half 2a and second outer half 2b to form housing 2 is achieved by means of eyelets 7a, 7b, 7c, 7d and 7e in which appropriate connection means, such as bolt-nut connections, may be arranged.

In embodiments wherein body 2 is a housing 2, the aforementioned fluid connection between fluid inlet 6 and nozzle 5 may be arranged in the inner space of housing 2. For example, the fluid connection may comprise a hose or tube (not shown) arranged in the inner space of housing 2 and fluidly connecting nozzle 5 to inlet 6. However, in more preferred embodiments, as 2 may be best derived from the appended FIG. 3, the fluid connection may be defined by the inner space V of housing 2, which can as depicted be a substantially torus shaped space V.

It is noted here that the skilled person will recognise that body 2 may be embodied by alternative means other than a housing. For example, in a (not depicted) alternative embodiment body 2 may be constituted by a hollow or solid body with the at least one nozzle 5 being embodied by a nozzle member in fluid connection to fluid inlet 6 by means of tubing.

In the described and illustrated exemplary embodiments of spray head 1, body 2 comprises a circular or ring shape. The skilled person will nevertheless recognise that the aforementioned advantageous effects of the present invention may likewise be achieved with a body 2 exhibiting an alternative closed shape that is not circular, such as a triangular or polygonal shape, but still fully encloses cleaning zone 4. Moreover, body 2 may alternatively comprise a non-closed shape, such as a U-shape, that still exhibits inner contour 3 partly enclosing cleaning zone 4 and having arranged there along at least one nozzle 5.

Referring again to FIG. 2, each one of nozzles 5 has a slit shape having a width W and a height H, the width W being larger than the height H. In the embodiment shown the width W extends in the circumferential direction of the opening 3, the height direction H perpendicular to the width direction W, parallel to the insertion direction I of the teat into the opening 3. A jet of fluid ejected through any one of nozzles 5 thus exhibits an approximately planar profile due to the slit shape of nozzle 5. Alternatively one or more, or all of the nozzles 5 can have the width W and height H extending in different directions. Alternatively the nozzles 5 can be formed by or comprise differently shaped openings, such as elliptical, oblong or circular.

In the depicted embodiment, each one of slit-shaped nozzles 5 is arranged to have its width extend along inner contour 3 of body 2. The aforementioned planar jet of fluid stemming from nozzle 5 is thus oriented to have its width oriented substantially perpendicular to a longitudinal direction of a teat received in cleaning zone 4, parallel to insertion direction I, which has been found to result in a particularly efficient cleaning of said teat.

In additional or alternative embodiments of spray head 1, at least one nozzle 5 may be configured to discharge fluid in a direction that is angled relative to a radial direction—said radial direction being approximately perpendicular to the aforementioned longitudinal direction I—of the teat when received in cleaning zone 4. The presence of such an angle of the ejected fluid jet has likewise been found to result in a further improved cleaning operation. Said angle of the ejected fluid jet may furthermore differ from one nozzle 5 to another one nozzle 5, resulting in a teat received in cleaning zone 4 to be simultaneously cleaned over a substantial portion of the length thereof. In addition, the angle of a forcefully ejected fluid jet to a radial direction of the teat may be sufficiently large to allow for fluid to be ejected in a longitudinal direction outside of cleaning zone 4. Such embodiments of spray head 1 are considered beneficial in cases in which it is desired to clean an area at which a teat of a dairy animal connects to its udder.

Spray head 1 preferably additionally comprises a brush 8a arranged at or near cleaning zone 4. Brush 8a is preferably arranged such that when a teat of the dairy animal is received in cleaning zone 4 brush 8a contacts said teat, thereby removing or at least loosening up debris or dirt attached to the teat. Moreover, during cleaning of a teat it may be expedient to move body 2 having attached thereto brush 8a in a longitudinal direction I of the to-be-cleaned teat to remove particularly firmly attached debris therefrom.

Spray head 1 may additionally or alternatively comprise a brush 8b at or near a side of body 2 for the removal of debris from a to-be-cleaned teat that is no received by cleaning zone 4.

FIG. 3 shows an exploded view of an exemplary embodiment of a spray head 1 in accordance with the present invention. In this embodiment of spray head 1, body 2 is embodied as a housing 2 comprising a first outer half 2a and a second outer half 2b that are each configured to be form fittingly attached to one another as shown. A firm mutual attachment of first outer half 2a and second outer half 2b may be achieved, for example, by eyelets 7a-7e having arranged therein connection means as described above. A waterproof seal (not shown) may be arranged at an interface between first outer half 2a and second outer half 2b. Such a waterproof seal may, for example, comprise a rubber-like material.

Housing 2 additionally comprises a first inner half 2a′ and a second inner half 2b′, that are likewise configured to be form fittingly attached to one another and arranged in between first and second outer halves 2a, 2b in an assembled state of spray head 1. In such an assembled state of spray head 1, the aforementioned inner space V of housing 2 is thus jointly formed by first and second outer halves 2a, 2b and first and second inner halves 2a′, 2b′, the inner space of housing 2 thereby extending in between the spaces defined respectively by first outer half 2a and first inner half 2a′ and second outer half 2b and second inner half 2b′.

Each one of first and second outer halves 2a, 2b furthermore comprises on an inner surface thereof a plurality of concentrically arranged ribs 10. Each one of ribs 10 is configured to be received in a respective one of a plurality of corresponding notches 11 arranged concentrically on inner surfaces of first and second inner halves 2a′, 2b′. Ribs 10 thus function as spacers between respectively first outer half 2a and first inner half 2a′ and second outer half 2b and second inner half 2b′ and define the slit-shaped nozzles 5 most clearly illustrated in FIG. 2.

In additional or alternative embodiments of the present invention, spray head 1 may additionally comprise a stimulator (not shown) configured to stimulate either one of both of an udder and a teat of a dairy animal by emitting kinetic pulses thereto.

Stimulation of the teats and/or udder of a dairy animal prior to milking has been found to stimulate the release of the peptide hormone oxytocin in the brain (paraventricular nucleus of the hypothalamus) of a dairy animal, which is associated with a decreased amount of time needed for milk let-down to occur and an increase in milk flow and total milk yield during milking.

The above described stimulator may comprises a motor that is powered electrically, pneumatically or alternatively by a flow of liquid through spray head 1 that is ultimately ejected through nozzles 5 as described above.

Referring now to FIG. 4, a more preferred embodiment of spray head 1 comprises an inner section 10. Inner section 10 is arranged in between first outer half 2a and second outer half 2b, both of which are substantially identical to first outer half 2a and second outer half 2b depicted in FIGS. 1-3. Inner section 10 may be considered to constitute a part of body 2 of spray head 1.

Inner section 10 is circular shaped and comprises a plurality of nozzles 12; of which each one is embodied by through hole in fluid connection with fluid inlet 6. The nozzles 12 can be the same as or similar to nozzles 5 as previously described. As can be discerned from FIG. 4, the plurality of nozzles 12 is arranged in proximity of an outer edge of inner contour 3 of circular inner section 10, and offset from a longitudinal center plane X of cleaning zone 4.

Each one of the plurality of nozzles 5, 12 is preferably configured to discharge a fluid jet 20 therefrom at an angle α away from the outer edge of cleaning zone 4 and/or substantially into a direction downwards towards a center or at least the center plane X of cleaning zone 4. As such, no or merely a minimal amount of fluid is dispersed upward out of cleaning zone 4, thereby preventing a user from splashing himself during use of spray head 1. Moreover, the directions of the plurality of fluid jets discharged by each one of nozzles 12 can result in the ejected fluid to exhibit a spiral-like motion, which has been found to result in an improved degree of cleaning, for example by providing the nozzles 5, 12 such that the jet 20 has a tangential component in its direction, as schematically shown in FIG. 1. However the or each jet 20 can also have a main direction radially towards the center of the opening 3.

In the embodiment depicted in FIG. 4, said angle at which fluid is discharged form nozzles 12 comprises 15-35 degrees, preferably 20-30 degrees, and more preferably 25 degrees. Said angle may be defined as an angle between a trajectory of the discharged fluid jet and a horizontal plane of cleaning zone 4 oriented substantially perpendicular to the aforementioned longitudinal direction I of cleaning zone 4.

In the embodiment depicted in FIG. 4, spray head 1 moreover comprises a diffusor 11. In the depicted preferred embodiment, diffusor 11 is embodied by a plurality of ribs 11 arranged along an inner perimeter of inner section 10, i.e. arranged along an inner contour of body 2 of spray head 1 and extending inward into cleaning zone 4. Each one of ribs 11 is arranged and configured to break up a fluid jet discharged through at least one of nozzles 12 to thereby reduce its momentum. Moreover, ribs 11 may contact a teat received by cleaning zone 4 to during cleaning rub off grime or dirt from said teat.

Each one of ribs 11 is at least partially arranged at a distance from an inner contour of inner section 10 or alternatively body 2 of spray head 1 to define a drainage space 13 there between. In the depicted embodiment, drainage space 13 extends along the inner perimeter of inner section 10 or inner contour of body 2; and is configured to receive therein fluid of which a momentum has been reduced by ribs 11. Fluid received within drainage space 13 may subsequently flow downward out of drainage space 13 along a fluid guide 15 arranged downstream of cleaning zone 4.

In the depicted embodiment of spray head 1, fluid guide 15 is a flange that is arranged at or near an edge of cleaning zone 4 situated substantially opposite the edge of cleaning zone 4 at or near which the one or more nozzles 12 is arranged. Here, fluid guide 15 extends along an inner perimeter of inner section 10 and is configured to guide and drain off fluid received from drainage space 13.

Spray head 1 moreover comprises a fluid guard 14 arranged downstream of the at least one nozzle. In the depicted embodiment, fluid guard 14 is likewise embodied by a flange extending along an inner perimeter of inner section 10 to prevent fluid from creeping upward out of drainage space 13. Consequently, nearly all fluid is forced downward to exit drainage space 13 along fluid guide 15, thereby preventing said fluid from splashing in unwanted directions during usage of spray head 15.

Spray head 1 according to FIG. 4 again is provided with a fluid inlet 6 into the internal space V for providing water or other cleaning fluids to the spray nozzle or nozzles 5, 12. The supply of cleaning fluid, such as water, can be a water mains, connected to the spray head by a hose. However, the cleaning fluid such as water can be supplied to a spray head 1 according to the disclosure by attaching a spray gun or similar high pressure supply to the fluid inlet 6. In such embodiment the fluid inlet 6 can be formed by or provided by an attachment plug (not shown) to which the pressure supply can be attached. The attachment plug can for example be a flexible plug, such as a rubber plug which can be forced over a nozzle of a spray gun or such pressure supply, for providing a fluid tight connection. Such spray gun can for example be but not limited to a known water gun.

In the embodiment of FIG. 4 there are three main parts 2a, 2b and 10 shown, assembled into the spray head. However, it is for example also possible to integrate for example one of the parts 2a, 2b with the inner section 10. The inner section 10 can be made of the same or a different material than the first and second parts 2a, 2b. The inner section 10 can for example be made of a softer material, such as for example rubber or an elastomeric material, agreeable to a teat. Such can further reduce the risk of unpleasant contact with a teat. Moreover this can increase the cleaning effectiveness of the spray head 1.

A spray head as disclosed in FIG. 4 can in alternative embodiments be provided with cleaning brush or brushes 8a and/or 8b similar to those as disclosed in FIG. 1-3.

A spray head 1 according to the present disclosure can be relatively light, and is preferably hand held during operation, for example by attaching it to a spray gun or similar high pressure supply, such that the spray head can be moved relatively easily between dairy animals and over and away from teats, and can be easily cleaned and maintained. In embodiments the at least one nozzle can comprise several openings 5, 12.

In other additional or alternative embodiments of the present invention, spray head 1 may furthermore comprise at least one sensor (not shown) configured to sense a value indicative of a level of cleanliness of a to-be-cleaned teat. The sensor may be a visual sensor configured to sense an amount of debris remaining on a to-be-cleaned teat and for this purpose may be arranged at an appropriate location, for example at or near cleaning zone 4. Alternatively, the sensor may be configured to sense an amount of fluid used to clean a to-be-cleaned teat; and/or measure an amount of time that has passed since cleaning of the to-be-cleaned teat has commenced.

In other additional or alternative embodiments of the present invention, spray head 1 may be comprised by a milking apparatus (not shown) from cleaning of a dairy animal teat prior to milking. Such milking apparatus may comprise automated (robotic) milking systems and traditional milking systems.

The aforementioned sensor may furthermore be connected to an indicator (not shown) comprised by or arranged on an exterior of spray head 1, wherein the indicator is configured to indicate whether a to-be-cleaned that has been sufficiently cleaned based on the value output by the sensor. The indicator may be a visual indicator comprising a light source. Alternatively, the indicator may be configured to output an audio signal.

It is emphasised here that the skilled person will recognise that the various features comprised by the various embodiments of the present invention may freely be combined without departing from the inventive concept in accordance present disclosure. For example, the skilled person will recognise that the brush 8b of the embodiment of spray head 1 depicted in FIG. 1 may likewise be included in the embodiment of spray head 1 depicted in FIG. 4. The present disclosure should therefore not be interpreted as being limited to the exemplary combinations of features of the various described embodiments.

The above described embodiments are intended only to illustrate the invention and not to limit in any way the scope of the present invention. Based on the above description of specific and particular embodiments of the present invention, the scope of protection according to the appended claims has been substantiated, whereas clearly additional and/or alternative embodiments are possible, feasible and potentially desirable within the scope of protection according to those appended claims. Features of the specific embodiments can not and should not result in limitation of the scope of protection thereto, unless defined in independent claims, whereas even the features defined in the appended independent claims can be replaced by obvious alternatives. Accordingly, it should be understood that where features mentioned in the appended claims are followed by reference signs, such signs are included solely for the purpose of enhancing the intelligibility of the claims and are in no way limiting on the scope of the claims. The scope of the invention is defined solely by the following claims.

1. Spray head configured to clean a teat of a dairy animal, comprising:
a body comprising an inner contour at least partly enclosing a cleaning zone that is configured to receive the teat of the dairy animal;
a fluid inlet; and
at least one nozzle that is configured to discharge a fluid jet, which at least one nozzle is in fluid connection with the fluid inlet and is arranged along at least part of the inner contour of the body.

2. Spray head according to claim 1, wherein the at least one nozzle is configured to discharge fluid in at least two different radial directions of the cleaning zone.

3. Spray head according to claim 1, wherein the inner contour of the body fully encloses the cleaning zone.

4. Spray head according to claim 1, further comprising a diffusor configured to break up the fluid jet discharged through the at least one nozzle, and wherein the diffusor comprises a plurality of ribs arranged along the inner contour of the body, wherein each one of the ribs is arranged and configured to break up the fluid jet.

5. (canceled)

6. Spray head according to claim 4, further comprising a drainage space disposed in between the inner contour of the body and the diffusor.

7. Spray head according to claim 1, wherein the body is a housing having an inner space, wherein the fluid connection is arranged in the inner space of the housing and is defined by the inner space of the housing, wherein the at least one nozzle is embodied by at least one aperture in the housing.

8. (canceled)

9. (canceled)

10. (canceled)

11. Spray head according to claim 1, wherein the at least one nozzle is configured to discharge the fluid jet therefrom at an angle towards a center of the cleaning zone at or near which said at least one nozzle is disposed.

12. Spray head according to claim 11, wherein the angle is between 15-35 degrees.

13. Spray head according to claim 1, further comprising a fluid guard arranged downstream of the at least one nozzle.

14. Spray head according to claim 1, further comprising a fluid guide arranged downstream of the cleaning zone.

15. Spray head according to claim 1, wherein the at least one nozzle has a slit shape having a width and a height.

16. Spray head according to claim 15, wherein the width of the at least one nozzle is extends along an inner contour of the body.

17. Spray head according to claim 1, wherein the at least one nozzle is configured to discharge fluid in a direction that is angled relative to a radial direction of the teat when received in the cleaning zone.

18. Spray head according to claim 1, further comprising at least one brush, which at least one brush is arranged at least at one of: in or near the cleaning zone and at or near a side of the body.

19. (canceled)

20. (canceled)

21. Spray head according to claim 1, wherein the fluid inlet comprises a connector configured to connect the fluid inlet to a fluid supply, such as a hose or a fluid gun.

22. (canceled)

23. A milking apparatus comprising a spray head according to claim 1.

24. Spray head according to claim 12, wherein the angle is between 20-30 degrees.

25. Spray head according to claim 24, wherein the angle is about 25 degrees.

26. Spray head according to claim 1, wherein the body is defined by a housing, comprising a first outer part and a second outer part, connectable to each other along a mid-sectional plane perpendicular to the insertion direction, wherein between said first outer part and said second outer part a first inner part and a second inner part are provided, wherein an inner space of the spray head is formed between the first and second outer parts and the first and second inner parts, wherein the series of nozzles is provided in proximity of an upper edge of the first inner part, offset from a longitudinal center plane of the cleaning zone, and wherein at least the lower one of said first and second inner part comprises inward reaching ribs.

27. Spray head configured to clean a teat of a dairy animal, comprising:
a body comprising an inner contour at least partly enclosing a cleaning zone that is configured to receive the teat of the dairy animal in an insertion direction;
a fluid inlet; and
at least one nozzle that is configured to discharge a fluid jet, which at least one nozzle is in fluid connection with the fluid inlet and is arranged along at least part of the inner contour of the body,
wherein the fluid inlet has a main direction of flow into the spray head substantially perpendicular to the insertion direction.

28. Spray head configured to clean a teat of a dairy animal, comprising:
a body comprising an inner contour at least partly enclosing a cleaning zone that is configured to receive the teat of the dairy animal in an insertion direction;
a fluid inlet; and
at least a series of nozzles, each nozzle configured to discharge a fluid jet, which series of nozzles is in fluid connection with the fluid inlet and is arranged along at least part of the inner contour of the body,
wherein the fluid nozzles are configured to discharge the fluid jet therefrom at an angle towards a center of the cleaning zone.

29. Spray head according to claim 28, wherein the fluid jets discharged from the nozzles pass alongside the center of the cleaning zone and wherein the insertion direction extends through said center of said cleaning zone.

30. Spray head according to claim 28, wherein the nozzles are provided in a first plane extending perpendicular to the insertion direction, wherein a ring shaped brush extends in a second plane adjacent said first plane.

31. Spray head according to claim 28, wherein the body is defined by a housing, comprising a first outer part and a second outer part, connectable to each other along a mid-sectional plane perpendicular to the insertion direction, wherein between said first outer part and said second outer part a first inner part and a second inner part are provided, wherein an inner space of the spray head is formed between the first and second outer parts and the first and second inner parts, wherein the series of nozzles is provided in proximity of an upper edge of the first inner part, offset from a longitudinal center plane of the cleaning zone. Wherein at least the lower one of said first and second inner part comprises inward reaching ribs.

32. Spray head according to claim 31, wherein a brush is provided between the first inner part and second inner part.

33. Spray head according to claim 28, wherein the nozzles are formed by slits.
